(19) United States
(12) Patent Application Publication
(10) Pub. No.: US 2005/0056361 A1
(43) Pub. Date: Mar. 17, 2005

(54) Method of recapping tires

(75) Inventors: Rodney Bailey, Simpsonville, SC (US); Peter Hetzel, Greer, SC (US)

Correspondence Address: Alan A. Csontos;Michelin North America, Inc., Intellectual Property Department, P.O. Box 2026, Greenville, SC, 29602, US

(73) Assignee: Michelin Recherche et Technique S.A.

(21) Appl. No.: 10/752,203

(22) Filed: Jan. 6, 2004

Related U.S. Application Data
(60) Provisional application No. 60/438,098, filed on Jan. 6, 2003.

(51) Int. Cl. B29D 30/56

(52) U.S. Cl. 156/96

(57) ABSTRACT

The present invention is a method for retreading a tire comprising a carcass comprising the step of spraying on the radially outermost surface of the carcass rubber comprising a curing accelerator in a thermoplastic matrix.

### FIELD OF THE INVENTION

The present invention is in the field of re-treaded tires.

### BACKGROUND OF THE INVENTION

The market for retreaded pneumatic tires is almost entirely a trucking market. In the trucking market, the carcass of a tire is expected to last several hundred thousand miles, and be amenable to having a new tread adhered to it several times. New truck tires are quite expensive, and are therefore bought with the expectation that their high initial costs are offset by the long service life of the carcass, and the low comparative cost of retreading.

A variety of procedures and different types of equipment are available for use in recapping or retreading pneumatic tires. One of the first steps in retreading a worn tire is to remove existing tread material from the tire carcass by a sanding procedure known as buffing. Next a layer of what is known as “cushion gum” is applied to the carcass. This layer of extruding uncured rubber may be stitched or adhesively bonded to the carcass. Next, a tread layer is applied atop the layer of cushion gum. In the cold recapping process, the tread is cured rubber, and has a tread pattern already impressed in its outer surface. The tire is then placed in an autoclave, and heated under pressure for an appropriate time to induce curing of the gum layer, and binding of the gum layer to the tread and the carcass. In the hot recapping process, the tread is uncured rubber, and has no tread pattern. The tire is then placed in a tire mold and heated under pressure for an appropriate time to cure the gum layer and the tread, and to cause the gum layer to bind with the tread and the carcass. [The term “cure” refers to the formation of cross-links between the elastomer molecules in the rubber compound].

However, currently there is a need to refrigerate the cushion gum to store it, due to the presence of vulcanization accelerators. Therefore, there is a need for an improved cushion gum, and an improved process of retreading.

### SUMMARY OF THE INVENTION

The present invention is a method for retreading a tire comprising a carcass comprising the step of spraying on the radially outermost surface of the carcass rubber comprising a curing accelerator in a thermoplastic matrix.

### DETAILED DESCRIPTION OF THE INVENTION

The present invention is a method for retreading a tire comprising a carcass comprising the step of spraying on the radially outermost surface of the carcass rubber comprising a curing accelerator in a thermoplastic matrix. In one embodiment of the invention, the thermoplastic matrix is selected from the group consisting of polymethylmethacrylate and polycarbonate. In one embodiment of the invention, the accelerators are selected from the group consisting of zinc dibenzyldithiocarbamate and diphenyl guanidine.

Currently, cushion gum must be shipped and stored in refrigerated containers, since it contains vulcanization accelerators. The present invention allows a longer storage life, and rapid curing at low curing temperatures, e.g. 125 degrees centigrade.

The invention may be further understood by means of the following non-limiting example.

### EXAMPLE 1

Three microencapsulated materials were prepared using a single emulsion evaporation process.

| Material | Final Weight (shell + core) | Percent Core Material |
|---|---|---|
| DPG/PC | 44.7 g | 18.2% |
| ZBEC/PMMA | 37.8 g | 13.4% |
| DPG/PMMA | 46.5 g | 16.2% |

The impact of the encapsulated accelerators was studied at temperatures ranging from 22 to 170 degrees centigrade. In all cases an increase in the t90 was observed.

ZBEC decomposition was measured by measuring the production of carbon disulfide, one of the decomposition products. The results indicated that encapsulation of DPG was effective in reducing the rate of ZBEC decomposition.

1. A method for retreading a tire comprising a carcass comprising the step of spraying on the radially outermost surface of the carcass rubber comprising a curing accelerator in a thermoplastic matrix.

2. The method of claim 1, wherein the matrix is selected from the group consisting of polymethylmethacrylate and polycarbonate.

3. The method of claim 1, wherein the accelerators are selected from the group consisting of zinc dibenzyldithiocarbamate and diphenyl guanidine.
